(19) United States
(12) Patent Application Publication
(10) Pub. No.: US 2025/0005442 A1
(43) Pub. Date: Jan. 2, 2025

(54) FEATURE REPRESENTATION BASED ON ZONE BASED DIVERSITY

(71) Applicant: INTERNATIONAL BUSINESS MACHINES CORPORATION, ARMONK, NY (US)

(72) Inventors: Venkata Nagaraju Pavuluri, New Rochelle, NY (US); Timothy Rea Dinger, Croton-on-Hudson, NY (US); Yuan-Chi Chang, Armonk, NY (US); Dharmashankar Subramanian, Rye Brook, NY (US)

(21) Appl. No.: 18/344,836

(22) Filed: Jun. 29, 2023

(51) Int. Cl. G06N 20/00

(52) U.S. Cl. CPC G06N 20/00

(57) ABSTRACT

A product and methodology is contemplated for monitoring a multivariate process. The product has a computer readable storage medium with program instructions embodied therewith. The program instructions are executable by a computer processor to cause the device to: segment data obtained from the multivariate process into a time series of snapshot intervals, each snapshot interval further segmented into a predetermined plurality of zone intervals; compute a contrastive metric from the segmented data for each variable during each zone interval; compare the computed contrastive metrics to one or more predetermined threshold values to define representationally relevant zone intervals for each variable; apply representation learning to derive zone-based feature vectors for each variable during the corresponding relevant zone intervals; and concatenate the zone-based feature vectors into a representation vector for the multivariate process during the time series of snapshots.

### BACKGROUND

The present disclosure generally relates to representation learning of time series data, and more particularly, to systems and methods of learning a reduced set of time-domain zone-based feature vectors for machine learning.

### SUMMARY

According to an embodiment of the present disclosure, a computer program product is provided for monitoring a multivariate process. The computer program product has a computer readable storage medium and program instructions embodied therewith. The program instructions are executable by a processor to cause the device to segment data obtained from the multivariate process into a time series of snapshot intervals, each snapshot interval further segmented into a predetermined plurality of zone intervals. The program instructions further compute a contrastive metric from the segmented data for each variable during each zone interval; compare the computed contrastive metrics to one or more predetermined threshold values to define representationally relevant zone intervals for each variable; apply representation learning to derive zone-based feature vectors for each variable during the corresponding relevant zone intervals; and concatenate the zone-based feature vectors into a representation vector for the multivariate process during the time series of snapshots.

In one embodiment, which may be combined with the preceding embodiment, a computer program product is provided that has one or more non-transitory computer-readable storage devices and program instructions stored on at least one of the one or more non-transitory storage devices. The program instructions are executable by a processor, and the program instructions include: instructions to segment data obtained from a multivariate process into a time series of snapshot intervals, each snapshot interval further segmented into a predetermined plurality of zone intervals; instructions to compute a contrastive metric from the segmented data for each variable during each zone interval; instructions to compare the computed contrastive metrics to one or more predetermined threshold values to define representationally relevant zone intervals for each variable; instructions to apply representation learning to derive zone-based feature vectors for each variable during the corresponding relevant zone intervals; and instructions to concatenate the zone-based feature vectors into a representation vector for the multivariate process during the time series of snapshots.

In one embodiment, a computer system is provided for monitoring a multivariate process. The computer system includes one or more processors, one or more computer-readable memories, one or more computer-readable tangible storage devices, and program instructions stored on at least one of the one or more storage devices for execution by at least one or more of the processors via at least one of the one or more memories. The computer system is capable of performing a method that includes segmenting data obtained from the multivariate process into a time series of snapshot intervals, each snapshot interval further segmented into a predetermined plurality of zone intervals; computing a contrastive metric from the segmented data for each variable during each zone interval; comparing the computed contrastive metrics to one or more predetermined threshold values to define representationally relevant zone intervals for each variable; applying representation learning to derive zone-based feature vectors for each variable during the corresponding relevant zone intervals; and concatenating the zone-based feature vectors into a representation vector for the multivariate process during the time series of snapshots.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a functional block diagram illustration of a computer hardware platform that can communicate with various networked components.

FIG. 2 illustrates an example computer system architecture for efficiently monitoring a process using machine learning.

FIG. 3 is a conceptual block diagram of the computer system architecture of FIG. 2 for processing sequence data, consistent with an illustrative embodiment.

FIG. 4 is a conceptual diagram of time series process data plotted in a snapshot interval of time which is segmented into first and second zone intervals of time.

FIG. 5 is a flowchart depicting illustrative steps in a method for assembling zone-based feature vectors to form a full vector representation for machine learning.

FIG. 6 depicts the time series process data in FIG. 4 grouped into two zone-based feature vectors.

FIG. 7 is a flowchart depicting illustrative steps in a method for identifying relevant zone-based feature vectors based on computing cross-snapshot contrastive variance.

FIG. 8 is a flowchart depicting illustrative steps in a method for identifying relevant zone-based feature vectors based on computing local temporal contrastive variance.

FIG. 9 is a flowchart depicting illustrative steps in a method for identifying relevant zone-based feature vectors based on computing zone density clustering.

FIG. 10 is a flowchart depicting reduced-cost-inferencing by assembling zone-based feature vectors.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

According to an aspect of the present disclosure, there is provided a computer program product for monitoring a multivariate process. The computer program product includes a computer readable storage medium having program instructions embodied therewith. The program instructions are executable by a processor to cause a computing device to segment data obtained from the multivariate process into a time series of snapshot intervals. The executed program instructions further cause each snapshot interval to be further segmented into a predetermined plurality of zone intervals. The executed program instructions further cause a contrastive metric to be computed from the segmented data for each variable during each zone interval. The executed program instructions further cause the computed contrastive metrics to be compared to one or more predetermined threshold values to define representationally relevant zone intervals for each variable. The executed program instructions further cause representation learning to be applied to derive zone-based feature vectors for each variable during corresponding relevant zone intervals. The executed program instructions further cause the zone-based feature vectors to be concatenated into a representation vector for the multivariate process during the time series of snapshots. The resulting concatenated representation vector reduces the amount of the time series data that must be computed to derive the representation. This improves the computing device's processing capabilities and reduces the processing overhead burden.

In some embodiments, the computer program product stores instructions that further cause the computing device to model the multivariate process by the representation vector based on machine learning. This provides inferential control of the process.

In some embodiments, the computer program product stores instructions that further cause the computing device to rank order the computed contrastive metrics for each variable during each zone interval. This provides a probabilistic reference for inclusion of the time series data into the zone-based feature vectors.

In some embodiments, the computer program product stores instructions that further cause the computing device to apply a tuning parameter to the rank order to define the relevant zone intervals for deriving the zone-based feature vectors. This provides for tailoring the zone-based representation vector to a particular downstream task.

In some embodiments, the computer program product stores instructions that further cause the computing device to compute the contrastive metrics by computing a variance of each variable at a predetermined time across all snapshot intervals. This computation facilitates identification of time ranges (i.e., intervals) manifest significant differences (e.g., greater than a predetermined threshold) across the snapshots.

In some embodiments, the computer program product stores instructions that further cause the computing device to aggregate the computed variances and apply a probabilistic function to select variables during each zone interval. This methodology is not intrinsically linked to other disclosed methodologies.

In some embodiments, the computer program product stores program instructions that further cause the computing device to apply a zone density clustering function to select variables during each zone interval. The zone density clustering identifies and groups variables manifesting significant differences together such that downstream representation learning techniques learn multiple variables together as opposed to one variable at a time.

In some embodiments, the computer program product stores instructions that further cause the computing device to compute the contrastive metrics by a first derivative of a variance of each variable at a predetermined time across all snapshot intervals. The first order and/or higher order derivatives capture the rates of change that are often present in facility measuring sensors such as pressure and light. Rapid rise or decline can be an indicator preceding an event of interest, such as pump failures.

According to an aspect of the present disclosure, there is provided a computer program product including one or more non-transitory computer-readable storage devices and program instructions stored on at least one of the one or more non-transitory storage devices. The program instructions are executable by a processor. The program instructions include instructions to segment data obtained from a multivariate process into a time series of snapshot intervals. The program instructions further segment each snapshot interval into a predetermined plurality of zone intervals. The program instructions further compute a contrastive metric from the segmented data for each variable during each zone interval. The program instructions further compare the computed contrastive metrics to one or more predetermined threshold values to define representationally relevant zone intervals for each variable. The program instructions further apply representation learning to derive zone-based feature vectors for each variable during corresponding relevant zone intervals. The program instructions further concatenate the zone-based feature vectors into a representation vector for the multivariate process during the time series of snapshots. The resulting concatenated representation vector reduces the amount of the time series data that must be computed to derive the representation. This improves the computing device's processing capabilities and reduces the processing overhead burden.

In some embodiments, the program instructions further comprise instructions to rank order the computed contrastive metrics for each variable during each zone interval. This provides a probabilistic reference for inclusion of the time series data into the zone-based feature vectors.

In some embodiments, the program instructions further comprise instructions to apply a tuning parameter to the rank order to define the relevant zone intervals for deriving the zone-based feature vectors. This provides for tailoring the zone-based representation vector to a particular downstream task.

In some embodiments, the program instructions further comprise instructions to compute the contrastive metrics by computing a variance of each variable at a predetermined time across all snapshot intervals.

In some embodiments, the program instructions further comprise instructions to aggregate the computed variances and apply a probabilistic function to select variables during each zone interval.

In some embodiments, the program instructions further comprise instructions to apply a zone density clustering function to select variables during each zone interval.

In some embodiments, the program instructions further comprise instructions to compute the contrastive metrics by a first derivative of a variance of each variable at a predetermined time across all snapshot intervals.

According to an aspect of the present disclosure, there is provided a computer system for monitoring a multivariate process. The computer system includes: one or more processors, one or more computer-readable memories, one or more computer-readable tangible storage devices, and program instructions stored on at least one of the one or more storage devices for execution by at least one or more of the processors via at least one of the one or more memories. The computer system is capable of performing a method comprising segmenting data obtained from the multivariate process into a time series of snapshot intervals. The method further segments each snapshot interval into a predetermined plurality of zone intervals. The method further computes a contrastive metric from the segmented data for each variable during each zone interval. The method further compares the computed contrastive metrics to one or more predetermined threshold values to define representationally relevant zone intervals for each variable. The method further applies representation learning to derive zone-based feature vectors for each variable during corresponding relevant zone intervals. The method further concatenates the zone-based feature vectors into a representation vector for the multivariate process during the time series of snapshots.

In some embodiments, the method includes computing the contrastive metrics by computing a variance of each variable at a predetermined time across all snapshot intervals.

In some embodiments, the method includes aggregating the computed variances and applying a probabilistic function to select variables during each zone interval.

In some embodiments, the method includes applying a probabilistic zone density clustering function to select variables during each zone interval.

In some embodiments, the method includes computing the contrastive metrics by a first derivative of a variance of each variable at a predetermined time across all snapshot intervals.

To better understand the features of the present disclosure, it may be helpful to discuss known architectures. To that end, the following detailed description illustrates various aspects of the present disclosure by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

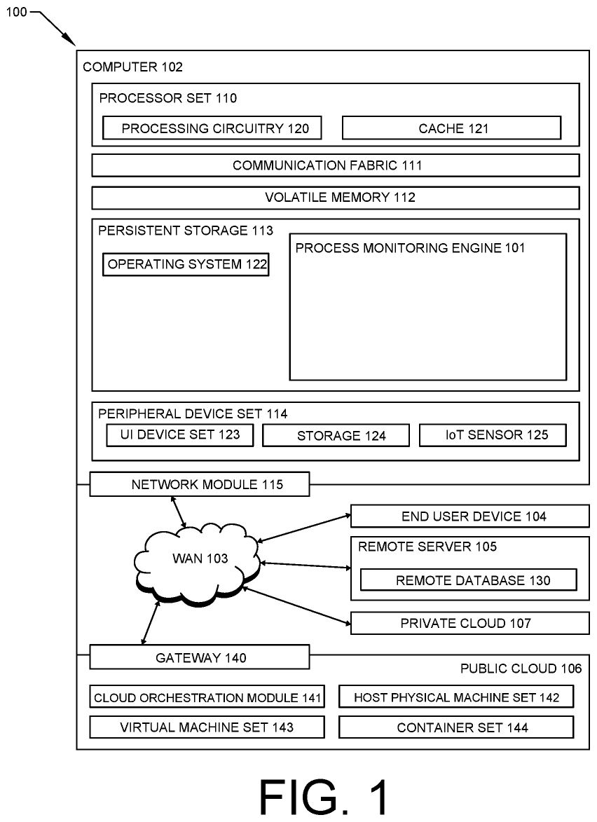

Referring to FIG. 1, computing environment 100 includes an example of an environment for the execution of at least some of the computer code involved in performing the inventive methods, including a process monitoring engine block 101. In addition to block 101, computing environment 100 includes, for example, computer 102, wide area network (WAN) 103, end user device (EUD) 104, remote server 105, public cloud 106, and private cloud 107. In this embodiment, computer 102 includes processor set 110 (including processing circuitry 120 and cache 121), communication fabric 111, volatile memory 112, persistent storage 113 (including operating system 122 and block 101, as identified above), peripheral device set 114 (including user interface (UI) device set 123, storage 124, and Internet of Things (IoT) sensor set 125), and network module 115. Remote server 105 includes remote database 130. Public cloud 106 includes gateway 140, cloud orchestration module 141, host physical machine set 142, virtual machine set 143, and container set 144.

COMPUTER 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 102 to cause a series of operational steps to be performed by processor set 110 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 101 in persistent storage 113.

COMMUNICATION FABRIC 111 is the signal conduction path that allows the various components of computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 102, the volatile memory 112 is located in a single package and is internal to computer 102, but, alternatively or additionally, the volatile memory may be distributed over multiple packages and/or located externally with respect to computer 102.

PERSISTENT STORAGE 113 is any form of non-volatile storage for computers that is now known or to be developed in the future. The non-volatility of this storage means that the stored data is maintained regardless of whether power is being supplied to computer 102 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 101 typically includes at least some of the computer code involved in performing the inventive methods.

PERIPHERAL DEVICE SET 114 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 102 to communicate with other computers through WAN 103. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 102 from an external computer or external storage device through a network adapter card or network interface included in network module 115.

WAN 103 is any wide area network (for example, the internet) capable of communicating computer data over non-local distances by any technology for communicating computer data, now known or to be developed in the future. In some embodiments, the WAN 103 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 104 is any computer system that is used and controlled by an end user (for example, a customer of an enterprise that operates computer 102), and may take any of the forms discussed above in connection with computer 102. EUD 104 typically receives helpful and useful data from the operations of computer 102. For example, in a hypothetical case where computer 102 is designed to provide a recommendation to an end user, this recommendation would typically be communicated from network module 115 of computer 102 through WAN 103 to EUD 104. In this way, EUD 104 can display, or otherwise present, the recommendation to an end user. In some embodiments, EUD 104 may be a client device, such as thin client, heavy client, mainframe computer, desktop computer and so on.

REMOTE SERVER 105 is any computer system that serves at least some data and/or functionality to computer 102. Remote server 105 may be controlled and used by the same entity that operates computer 102. Remote server 105 represents the machine(s) that collect and store helpful and useful data for use by other computers, such as computer 102. For example, in a hypothetical case where computer 102 is designed and programmed to provide a recommendation based on historical data, then this historical data may be provided to computer 102 from remote database 130 of remote server 105.

PUBLIC CLOUD 106 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 106 is performed by the computer hardware and/or software of cloud orchestration module 141. The computing resources provided by public cloud 106 are typically implemented by virtual computing environments that run on various computers making up the computers of host physical machine set 142, which is the universe of physical computers in and/or available to public cloud 106. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 106 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 107 is similar to public cloud 106, except that the computing resources are only available for use by a single enterprise. While private cloud 107 is depicted as being in communication with WAN 103, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 106 and private cloud 107 are both part of a larger hybrid cloud.

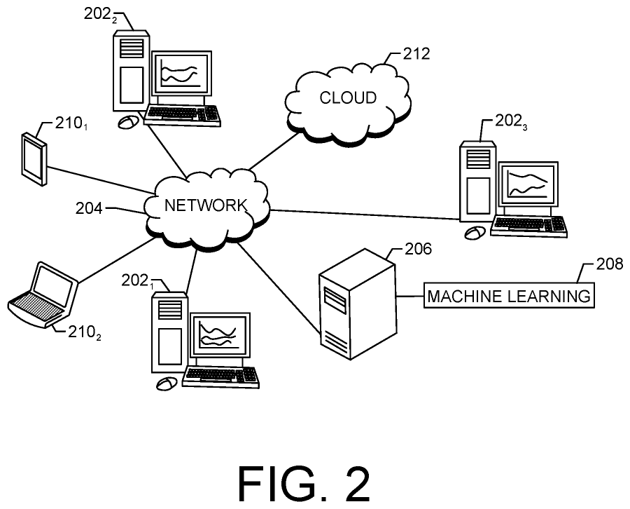

FIG. 2 depicts an illustrative computer system architecture for remotely communicating with and controlling one or more different process monitors 202 in accordance with embodiments of this technology. The process monitors 202 can be monitoring industrial processes, health care diagnosis and treatment processes, financial and business processes, and the like without limitation. Each process monitor 202 typically employs a great number of sensors collecting data that can be remotely distributed via software applications over a network 204. For example, without limitation, an array of such programmed sensors can provide real time information needed for sophisticated computer control of the process monitor 202, such as via Internet of Things (“IoT”) technology. A centralized analytics service server 206 can use the sensor information to model the processes for example by performing machine learning 208. The phrase “machine learning” broadly describes a function of an electronic system that learns from data. A machine learning system, engine, or module can include a trainable machine learning algorithm that can be trained, such as in an external cloud environment, to learn functional relationships between inputs and outputs that are currently unknown.

Machine learning engine 208 can be utilized to solve a variety of technical issues (e.g., learning previously unknown functional relationships) in connection with technologies such as, but not limited to, machine learning technologies, time-series data technologies, data analysis technologies, data classification technologies, data clustering technologies, trajectory/journey analysis technologies, medical device technologies, collaborative filtering technologies, recommendation system technologies, signal processing technologies, word embedding technologies, topic model technologies, image processing technologies, video processing technologies, audio processing technologies, and/or other digital technologies.

Other computing devices 210 can communicate with the network 202 to remotely monitor and control the process monitors 202. These computing devices 210 can include stationary computing devices such as desktop computers and enterprise computing systems, as well as portable computing devices such as laptop computers, portable handsets, smart-phones, tablet computers, personal digital assistants (“PDAs”), smart watches, and the like.

The network 204 can be, but is not limited to, a local area network (“LAN”), a virtual private network (“VPN”), a cellular network, the Internet, combinations thereof, and the like. For example, the network 204 can include a mobile network that is communicatively coupled to a private network, sometimes referred to as an intranet that provides various ancillary services, such as communication with various application stores, libraries, and the Internet. The network 204 enables the machine learning engine 208, which is a software program running on the analytics server 206, to communicate with training data produced by the sensors for the respective process monitors 202, the computing devices 210, and the cloud 212 to perform machine learning for all the process monitors 202.

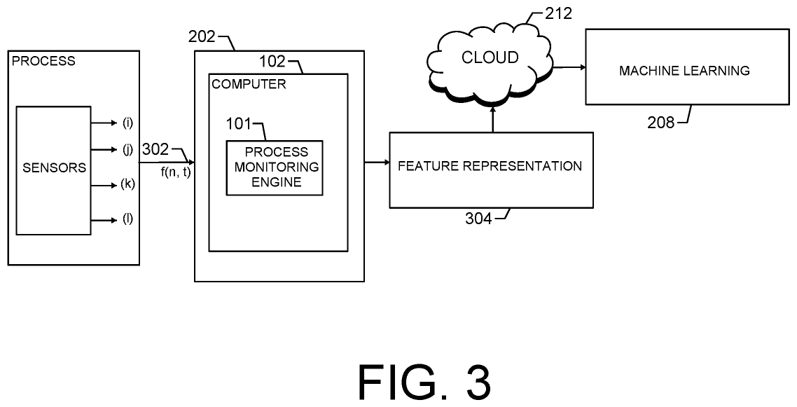

FIG. 3 diagrammatically depicts one of the process monitors 202 of FIG. 2 including the computer 102 of FIG. 1 in accordance with illustrative embodiments. In this non-limiting example, the process monitor 202 involves at least four process variables denoted i, j, k, l that are monitored by one or more sensors. The sensor values are received by the computer 102, which segments the sensor values into sequential, time series data reflecting the instantaneous value of each process variable i, j, k, l at each increment of time over an interval from (t)=ti to (t)=tn. The computer 102 transforms the time series sensor data into a feature representation 304 that is compatible for use by the machine learning engine 208.

The phrase “time-series data” can refer to a sequence of data that is repeatedly generated and/or captured by a device (a specialized computing device) at a plurality of time values during a certain time interval. Examples of time-series data include the continuous monitoring of a person's heart rate, hourly readings of air temperature, monthly rainfall data, and the like. Time-series data can be analyzed to understand the underlying structures and functions that produce the observations. Understanding the mechanisms of time-series data allows a mathematical model to be developed that explains the data in such a way that prediction, monitoring, and/or control can occur. The present embodiments are applicable to analysis of a variety of variable types that are part of time-series data, for example variables having two class types and/or variables having more than two possible classes, and variables having numerical values along a scale of possible values.

Accordingly, the process monitor 202 has a specialized processing unit such as a time series data component and the like for carrying out computations related to machine learning. The computer system is thereby specifically configured to provide technical improvements to time series data systems, machine learning systems, artificial intelligence systems, and systems of data analysis systems such as but not limited to data classification systems, data regression systems, data clustering systems, and the like. The machine learning output can further provide one or more inferences, provide one or more predictions, and/or determine one or more relationships among the time series process data. For example, a machine learning model generated based on the representation vector produced as described herein may model the multivariate process by providing one or more inferences and/or predictions and/or by determining one or more relationships amongst the variables analyzed in the time series process data.

The machine learning component can employ any suitable machine-learning based techniques, statistical-based techniques and/or probabilistic-based techniques. For example, the machine learning engine 208 and/or a machine learning component of the process monitor 202 can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, and the like. For example, the machine learning engine 208 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of support vector regression machine learning computations, a set of k-means machine learning computations, a set of spectral clustering machine learning computations, Gaussian mixture model machine learning computations, a set of regularization machine learning computations, a set of rule learning machine learning computations, a set of Bayesian machine learning computations, a set of deep Boltzmann machine computations, a set of deep belief network computations, a set of convolution neural network computations, a set of stacked auto-encoder computations and/or a set of different machine learning computations.

Accordingly, the computer system generally facilitates machine learning with a process monitor 202 using time series data in accordance with one or more embodiments illustratively described herein. For example, the time series data can be related to a machine learning system, an artificial intelligence system, a collaborative filtering system, a recommendation system, a signal processing system, a word embedding system, a topic model system, an image processing system, a data analysis system, a media content system, a video-streaming service system, an audio-streaming service system, an e-commerce system, a social network system, an internet search system, an online advertisement system, a medical system, an industrial system, a manufacturing system, and/or another digital system. The system can employ hardware and/or software to solve problems that are highly technical in nature, that are not abstract and that cannot be performed as a set of mental acts by a human.

For simplicity of explanation, the specialized-computer-implemented methods are depicted and described as a series of acts. It is to be understood and appreciated that the subject innovation is not limited by the acts illustrated and/or by the order of acts. That is, for example, acts can occur in various orders and/or concurrently, and with other acts not presented and described herein. Furthermore, not all expressly disclosed acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from a computer-readable device or storage media.

The system can employ hardware and/or software to solve problems that are highly technical in nature, that are not abstract and that cannot be performed as a set of mental acts by a human. One or more embodiments of the system can also provide technical improvements to a computer processing unit associated with a machine learning process by improving processing performance of the computer processing unit, reducing computing bottlenecks of the computer processing unit, improving processing efficiency of the computer processing unit, and/or reducing an amount of time for the computer processing unit to perform the machine learning process.

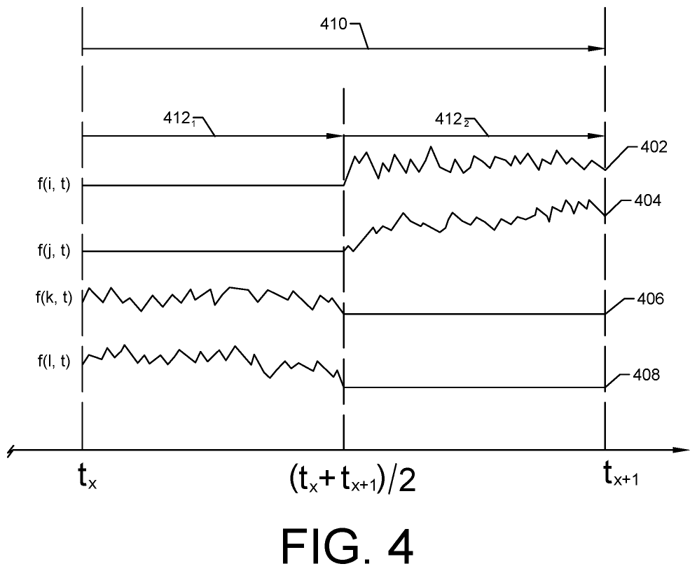

Turning now to FIG. 4, FIG. 4 is a simplified depiction of time series data about the multivariate process that is obtained from the sensors 302. The time-varying values of each variable i 402, j 404, k 406, l 408 are aligned by indexing them as a function of time f(n,t). The time index (t) is segmented into a consecutive time series of snapshot intervals 410, with FIG. 4 depicting one such snapshot interval 410 spanning from t=tₓ to t=tₓ+i. Each snapshot interval 410 is further segmented into a predetermined plurality of zone intervals 412. For purposes of this illustrative simplified description the snapshot interval 410 is segmented into two zones 412₁, 412₂. Furthermore, in these simplified illustrative embodiments it is observed that variation occurs in variable k 406 and variable l 408 only during the first zone interval 412₁. Similarly, variation is observed in variable i 402 and variable j 404 only during the second zone interval 412₂. This can indicate the components of the process 202 monitored as variables i and j are only activated during the second zone interval 412₂ in this snapshot interval 410. For example, without limitation, the variables i and j can reflect the speed and pressure of a pump that was inactivated during the first zone interval 412₁ but was activated during the second zone interval 412₂. In an industrial process there can be a large number of variables, sometimes on the order of hundreds of thousands, that can overwhelm a monitoring system's ability to employ machine learning to effectively capture the structure of the multivariate data. Many uncorrelated variables can introduce noise, rather than patterns, to deteriorate model learning. Signals of interest, such as precursors to an alarm, can manifest in a small subset of all the variables which are simply not relevant to accurately predicting the alarm.

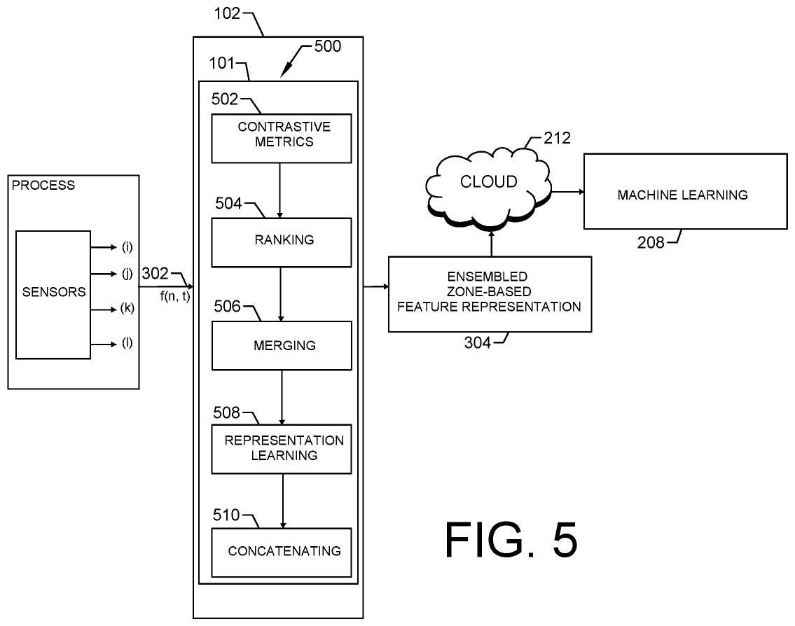

The specialized computer 102 filters each variable's indexed time series data to discriminate those zone intervals 412 in which high activity is observed, such as in zone interval 412₂ for variables i and j, from the other zone intervals 412 in which low activity is observed, such as in zone interval 412₁ for process variables i and j. The terms “high activity” and “low activity” generally define which zone intervals 412 are relevant for purposes of generating the feature representation 304 modeling the process for machine learning 208. FIG. 5 is a flowchart depicting steps in a method 500 by which the specialized computer 102 can discriminate only those zone intervals 412 for each process variable i, j, k, l that are relevant in computing the feature representation 304.

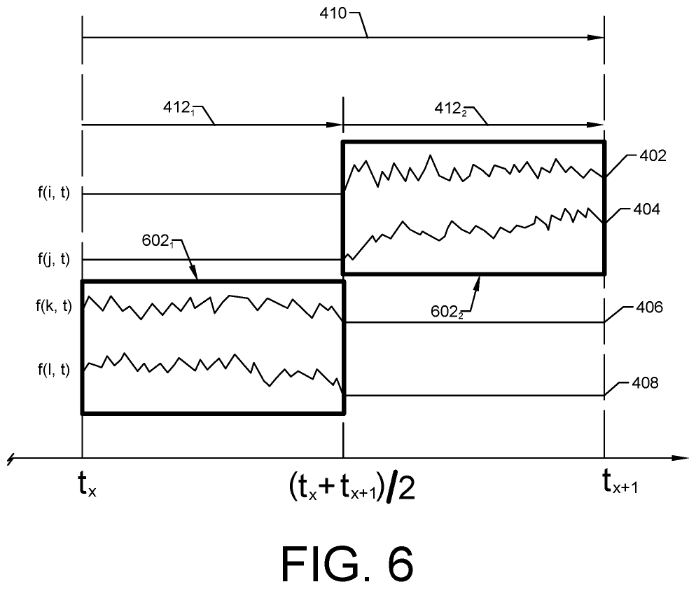

In the illustrative embodiments of FIG. 5 the process monitoring engine 101 is programmed to receive the segmented time series process data and, by executing blocks 502-510, outputs the feature representation 304 for machine learning 208. Beginning in block 502, contrastive metrics V(n, t) are computed for each of the variables i, j, k, l during each zone interval 412. These contrastive metrics V(n, t) are computed for each of a predetermined number of time periods in each zone interval 412. Block 504 then ranks the time periods for each process variable i, j, k, l from the highest contrastive metric to the lowest contrastive metric. The identification of the relevant time periods/zone intervals for a particular variable occurs, in block 504 and in other steps described herein, via automated performance of the described methods/programs and without a need for any manual labeling of the time series zone intervals. In some instances, the relevant zone intervals may be referred to as high contrast zones. Block 506 merges consecutive time periods for each process variable i, j, k, l into their respective zones, along with respective subsets of the process variable values from the time series data. Block 508 applies representation learning to the highly active, or relevant, zone intervals 412 to compute zone-based feature vectors for the process variables i, j, k, l. The code may perform representation learning using various techniques such as multi-kernel convolution, triplet loss, transformers, etc. to the relevant zone intervals 412 to produce the zone-based feature vectors. Staying with FIG. 5 while also considering FIG. 6, which depicts a zone-based feature vector 602₁ computed for the first zone interval 412₁ of the snapshot 410, which in these illustrative embodiments is a relevant zone only for process variables k and l. Likewise, another zone-based feature vector 602₂ is computed for the second zone interval 412₂ of the snapshot 410, which is a relevant zone only for process variables i and j. Block 510 in FIG. 5 concatenates the zone-based feature vectors 602₁, 602₂ for the snapshot 410 depicted in FIG. 6, along with other similarly computed zone-based feature vectors 602 for all of the other snapshot intervals of the time series data. This ensembling derives the full representation vector 304 for process variables i, j, k, l of the multivariate process being monitored during the time series of snapshot time intervals.

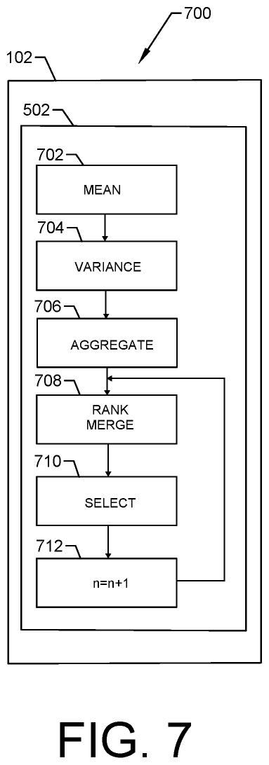

FIG. 7 is a flowchart more particularly describing steps in a method 700 that are executed by the specialized computer 102 for computing the contrastive metrics in block 502 discussed above, based on cross-snapshot variance. In block 702 a moving window average is computed for each variable i, j, k, l of the time series process data. In block 704 variance V(t), or what is sometimes referred to as entropy, values are computed for predetermined time periods (t) of each snapshot interval 410n. Block 706 aggregates V(n, t) for each process variable i, j, k, l and across all snapshot intervals 410n at the same time period (t). For example, without limitation, the aggregate variance V(t) can be computed in terms of:

$$V ( t ) = λ ( {\sum }_{n} V ( n , t ) ) + ( 1 - λ ) max V ( n , t )$$

Block 708 ranks V(t) for each process variable i, j, k, l from high to low and aligns it and the corresponding subsets of process variable data to the snapshot intervals 410n. Block 710 applies a probabilistic function, such as the Softmax function, to V(t) to select only the relevant process variable values for inclusion in the zone-based vectors 602. In some embodiments, all process variable values which equal or exceed a threshold value are deemed relevant in block 710. The threshold value is predetermined or automatically calculated based on the range of values for a particular variable. Block 712 returns control back to block 708 for computing the relevant zones 412 for the next process variable i, j, k, l according to this method.

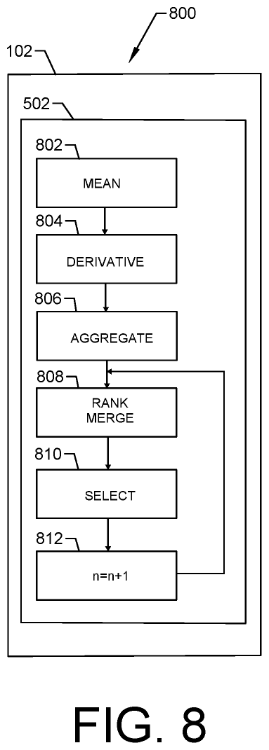

FIG. 8 depicts steps in an alternative method 800 that are executed by the specialty computer 102 for computing the contrastive metrics discussed above. Instead of being based on the variance values computed in block 704 of FIG. 7, block 804 in the method of FIG. 8 instead computes slope values, or the rate of delta change, for each process variable i, j, k, l of the time series data. This can be done by computing the contrastive metrics in terms of a first derivative of the variance of each process variable at a predetermined time period or periods across all the snapshot intervals 410:

$$V ( n , t ) = D ( n , t + 1 ) - D ( i , t )$$

Otherwise, the steps of method 800 mirror those of method 700 in these illustrative embodiments. In block 802 a moving window average is computed for each variable i, j, k, l of the time series process data. In block 804 variance V(t), or entropy, values are computed for predetermined time periods (t) of each snapshot interval 410n. Block 806 aggregates V(n, t) for each process variable i, j, k, l and across all snapshot intervals 410n at the same time period (t). For example, without limitation, the aggregate variance V(t) can be computed in terms of:

$$V ( t ) = λ ( {\sum }_{n} V ( n , t ) ) + ( 1 - λ ) max V ( n , t )$$

Block 808 ranks V(t) for each process variable i, j, k, l from high to low and aligns it and the corresponding subsets of process variable data to the snapshot intervals 410n. Block 810 applies a probabilistic function, such as the Softmax function, to V(t) to select only the relevant process variable values for inclusion in the zone-based vectors 602. In some embodiments, all process variable values which equal or exceed a threshold value are deemed relevant in block 710. The threshold value is predetermined or automatically calculated based on the range of values for a particular variable. Block 812 returns control back to block 808 for computing the relevant zones 412 for the next process variable i, j, k, l according to this method.

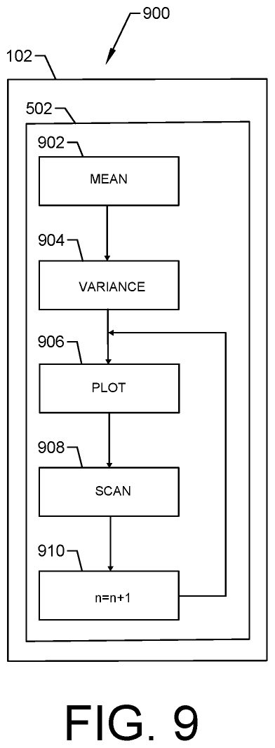

FIG. 9 depicts steps in another alternative method 900 that are executed by the specialty computer 102 for computing the contrastive metrics discussed above. Similar to method 700 in FIG. 7, in block 902 a moving window average is computed for each variable i, j, k, l of the time series process data. In block 904 variance V(t), or entropy, values are computed for predetermined time periods (t) of each snapshot interval 410n. But instead of aggregating the process variable variances, block 906 in the method 900 instead shuffles the time indexed variance within a two-dimensional plane. Block 908 then applies a probabilistic zone density clustering function, such as DBSCAN and the like, to select the relevant zone intervals and the corresponding time series data for each process variable i, j, k, l of the time series data. In some embodiments, all process variable values which equal or exceed a threshold value are deemed relevant in block 710. The threshold value is predetermined or automatically calculated based on the range of values for a particular variable. Block 910 then returns control back to block 906 for computing the relevant zones 412 for the next process variable i, j, k, l according to this method.

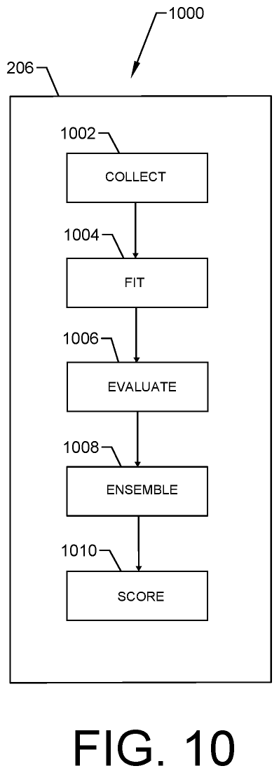

FIG. 10 is a flowchart depicting steps in a method 1000 that can be executed by the centralized server 206, for all the process monitors 202, to apply the assembled zone vectors 602 to a downstream task. Block 1002 obtains the assembled representation 304 from the remote process monitor 202, allocating a portion of its representation vectors to training data and another portion of its representation vectors to test data. Block 1004 fits the downstream task with a probabilistic model, such as a classification or regression model. Block 1006 then evaluates individual or grouped zone-based vector contribution to the downstream task performance by incrementally removing ill-fitting zone-based vectors 602. Removing zone-based vectors 602 that are of least significance to the downstream task at hand, for example, can improve the modeling performance. Block 1008 generates a predictive model based only on the non-removed zone-based vectors. Finally, block 1010 computes only the non-removed zone-based vectors in scoring the downstream task.

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

It is to be appreciated that the computer system (e.g., the specialized computer 102, the process monitoring engine 101, and/or the machine learning engine 208) performs acts on the time series data from the process monitors 202 that cannot be performed by a human (e.g., is greater than the capability of a single human mind). For example, an amount of time series data processed, a speed of processing of times series data and/or data types of the time series data processed by the time series data over a certain period of time can be greater, faster and different than an amount, speed and data type that can be processed by a single human mind over the same period of time. The computer system can also be fully operational towards performing one or more other functions while also performing the above-referenced conditioning of the time series data for purposes of machine learning. Moreover, machine learning output generated by computer system can include information that is impossible to obtain manually by a user. For example, an amount of information included in the machine learning output and/or a variety of information included in the machine learning output can be more complex than information obtained manually by a user.

Moreover, because at least generating a reduced-feature zone-based representation 304 is established from a combination of electrical and mechanical components and circuitry, a human is unable to replicate or perform processing performed by the computer system (e.g., specialized computer 102, process monitoring engine 101) disclosed herein. For example, a human is unable to communicate time series data and/or process time series data associated with optimizing the feature representation 304 to only zone-based vectors that are relevant for a given downstream task. Furthermore, a human is unable to execute a machine learning model based on a zone-based reduced feature set associated with time series data.

Additionally, the specialized computer 102 significantly improves the operating efficiencies of the computer system by ensembling the zone-based vector representation in response to any particular downstream task. Transmitting custom-tailored reduced vector feature representations as disclosed herein intentionally and significantly eliminates the need to transmit large volumes of time series data that is of no effect in the machine learning. This frees up computer system processing overhead and storage capacities to attend to more important processes, generally reducing the overall cost of machine learning.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer program product for monitoring a multivariate process, the computer program product comprising a computer readable storage medium having program instructions embodied therewith, the program instructions executable by a processor to cause a computing device to:
segment data obtained from the multivariate process into a plurality of zone intervals of a time series;
compute a contrastive metric from the segmented data for each variable during each zone interval;
compare the computed contrastive metrics of each zone interval for each variable to each other to define representationally relevant zone intervals for each variable;
apply representation learning to derive zone-based feature vectors for each variable during corresponding zone intervals of the representationally relevant zone intervals; and
concatenate the zone-based feature vectors into a representation vector that represents the multivariate process during the time series.

2. The computer program product of claim 1, wherein the program instructions further cause the computing device to model the multivariate process by the representation vector based on machine learning.

3. The computer program product of claim 2, wherein the program instructions further cause the computing device to adjust the model via:
removing a first zone-based feature vector from the zone-based feature vectors, the first zone-based feature vector being least relevant of the representationally relevant zone intervals based on the comparison of the computed contrastive metrics;
concatenating the remaining zone-based feature vectors into a modified representation vector; and
training the model on the modified representation vector.

4. The computer program product of claim 1, wherein the program instructions further cause the computing device to rank order the computed contrastive metrics for each variable during each zone interval.

5. The computer program product of claim 1, wherein the program instructions further cause the computing device to compute the contrastive metrics by computing a variance of each variable at a predetermined time across the time series.

6. The computer program product of claim 5, wherein the program instructions further cause the computing device to aggregate the computed variances and apply a probabilistic function to select variables during each zone interval.

7. The computer program product of claim 5, wherein the program instructions further cause the computing device to apply a zone density clustering function to select variables during each zone interval.

8. The computer program product of claim 1, wherein the program instructions further cause the computing device to compute the contrastive metrics by a first derivative of a variance of each variable at a predetermined time across the time series.

9. A computer-implemented method comprising:
segmenting data obtained from a multivariate process into a plurality of zone intervals of a time series;
computing a contrastive metric from the segmented data for each variable during each zone interval;
comparing the computed contrastive metrics of each zone interval for each variable to each other to define representationally relevant zone intervals for each variable;
applying representation learning to derive zone-based feature vectors for each variable during corresponding zone intervals of the representationally relevant zone intervals; and
concatenating the zone-based feature vectors into a representation vector that represents the multivariate process during the time series.

10. The computer-implemented method of claim 9, the method further comprising:
modeling the multivariate process by the representation vector based on machine learning.

11. The computer-implemented method of claim 10, the method further comprising adjusting the model via:
removing a first zone-based feature vector from the zone-based feature vectors, the first zone-based feature vector being least relevant of the representationally relevant zone intervals based on the comparison of the computed contrastive metrics;
concatenating the remaining zone-based feature vectors into a modified representation vector; and
training the model on the modified representation vector.

12. The computer-implemented method of claim 9, the method further comprising rank ordering the computed contrastive metrics for each variable during each zone interval.

13. The computer-implemented method of claim 9, the method further comprising computing the contrastive metrics by computing a variance of each variable at a predetermined time across the time series.

14. The computer-implemented method of claim 13, the method further comprising aggregating the computed variances and applying a probabilistic function to select variables during each zone interval.

15. The computer-implemented method of claim 9, the method further comprising computing the contrastive metrics by a first derivative of a variance of each variable at a predetermined time across the time series.

16. A computer system for monitoring a multivariate process, the computer system comprising:
one or more processors, one or more computer-readable memories, one or more computer-readable tangible storage devices, and program instructions stored on at least one of the one or more storage devices for execution by at least one or more of the processors via at least one of the one or more memories, wherein the computer system is capable of performing a method comprising:
segmenting data obtained from the multivariate process into a time series of snapshot intervals, each snapshot interval further segmented into a predetermined plurality of zone intervals;
computing a contrastive metric from the segmented data for each variable during each zone interval;
comparing the computed contrastive metrics to one or more predetermined threshold values to define representationally relevant zone intervals for each variable;
applying representation learning to derive zone-based feature vectors for each variable during corresponding relevant zone intervals; and
concatenating the zone-based feature vectors into a representation vector for the multivariate process during the time series of snapshots.

17. The computer system of claim 16, further capable of performing a method comprising computing the contrastive metrics by computing a variance of each variable at a predetermined time across all snapshot intervals.

18. The computer system of claim 17 further capable of performing a method comprising aggregating the computed variances and applying a probabilistic function to select variables during each zone interval.

19. The computer system of claim 17 further capable of performing a method comprising applying a probabilistic zone density clustering function to select variables during each zone interval.

20. The computer system of claim 16 further capable of performing a method comprising computing the contrastive metrics by a first derivative of a variance of each variable at a predetermined time across all snapshot intervals.
